(19) United States
(12) Patent Application Publication
(10) Pub. No.: US 2010/0194997 A1
(43) Pub. Date: Aug. 5, 2010

(54) LIGHTING DEVICE FOR DISPLAY DEVICE, DISPLAY DEVICE AND TELEVISION RECEIVER

(75) Inventor: Mitsuhiro Takeba, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/679,331

(22) PCT Filed: May 16, 2008
(86) PCT No.: PCT/JP2008/059037

§ 371 Date: Mar. 22, 2010

(30) Foreign Application Priority Data
Sep. 28, 2007 (JP) 2007-254647

(51) Int. Cl. H04N 5/44; G02F 1/13357

(52) U.S. Cl. 348/725; 362/97.1; 362/97.2; 348/E05.096

(57) ABSTRACT

A lighting device 12 for a display device of the present invention includes a plurality of linear light sources 17 and light source holding members 20 for holding the linear light sources 17. Each light source holding member 20 has the first member 30 and the second member 40. The first member 30 has the first light source holding member 31 that directly holds the first linear light source 17a of the linear light sources 17. The second member 40 has the second light source holding member 41 that directly holds the second linear light source 17b that is different from the first linear light source 17a. The light source holding member 20 has means of changing a distance between light source holding portions 33, 43 for changing a distance between the first light source holding portion 31 and the second light source holding portion 41.

### TECHNICAL FIELD

The present invention relates to a lighting device for a display device, a display device and a television receiver.

### BACKGROUND ART

A liquid crystal panel used for a liquid crystal display device such as a liquid crystal television does not emit light itself. Therefore, it requires a backlight device as a separate lighting device. The backlight device is usually disposed behind the liquid crystal panel (i.e., on an opposite side from a display surface). The backlight device includes a metal or resin chassis having an opening on a liquid crystal panel side. It also includes many fluorescent tubes (e.g., cold cathode tubes) housed in the chassis as lamps and many pieces of optical members (diffusing sheet and the like) disposed around the opening of the chassis for effectively transmitting light emitted from the lamps toward the liquid crystal panel side. It further includes lamp clips for holding the elongated tubular cold cathode tubes to the chassis. An example of such lamp clips is disclosed in Patent Document 1.

Patent Document 1: JP-A-2006-286341

### Problem to be Solved by the Invention

The lamp clips disclosed in Patent Document 1 are for positioning and supporting a plurality of fluorescent tubes behind a liquid crystal panel. Each of them has a reception portion for receiving a part of the fluorescent tube by surrounding a part of periphery of the fluorescent tube. It also has a protruding portion that becomes tangent to a part of the outer periphery of the fluorescent tube for supporting the fluorescent tube spaced apart from the inner surface of the reception portion that faces the part of the outer periphery of the fluorescent tube. To improve assembly work efficiency, one lamp clip generally has a plurality of reception portions so that one lamp clip can hold a plurality of fluorescent tubes as describe in Patent Document 1.

Such lamp clips are capable of defining arrangement patterns of lamps when they are mounted to the chassis. Because lamp holding portions are provided in fixed locations on the lamp clips, one lamp clip defines only one lamp arrangement pattern. Therefore, the same lamp clips cannot be used for lamps to be arranged in different arrangement patterns.

As a result, lamp clips need to be designed and manufactured exclusively for respective lamp arrangement patterns. For different lamp arrangement patterns, for example, for liquid crystal television in different sizes, different lamp clips are required according to the sizes. Even when the liquid crystal televisions are in the same size, the number of lamps or the lamp arrangement pattern may be different in consideration of cost and performance. In such a case, the same problem as in the above case occurs. This is very inefficient and leads to an increase in cost.

Furthermore, the lamps may not be arranged at an equal interval in one backlight device. For example, the lamps may be arranged at a small interval in the central section of the backlight device and at a large interval in end sections of the backlight device (i.e., uneven lamp pitch). In this case, different lamp clips are required for the backlight device. This leads to an increase in cost. Moreover, the lamp clips need to be sorted into different types during assembly work and the sorting is time consuming.

### DISCLOSURE OF THE PRESENT INVENTION

The present invention was made in view of the foregoing circumstances, and an object thereof is to provide a lighting device for a display device that can accommodate different arrangement intervals of the light sources and contribute to cost saving. Another object of the present invention is to provide a display device having such a lighting device and a television receiver having such a display device.

### Means for Solving the Problem

A lighting device for a display device of the present invention includes a plurality of linear light sources and light source holding members for holding the linear light sources. The light source holding member has the first member and the second member. The first member has the first light source holding portion for directly holding the first linear light source of the linear light sources. The second member has the second light source holding portion for directly holding the second linear light source that is different from the first linear light source. The light source holding member has means of changing a distance between light source holding portions for changing a distance between the first light source holding portion and the second light source holding portion.

According to such a lighting device for a display device, the distance between the first light source holding portion in the first member and the second light source holding portion in the second member can be changed with means of changing a distance between light source holding portions. Therefore, the interval between the light source holding portions can be set differently for one light source holding member. As a result, when different cold cathode tubes are held by those lamp holding portions, the distance between the cold cathode tubes held by the same light source holding member can be set differently. The same light source holding member can be used even when the cold cathode tubes are arranged at different intervals, for example.

For holding linear light sources arranged at different intervals, design and manufacturing light source holding members having a plurality of light source holding portions for accommodating the different intervals are not required. For example, even if display devices require different arrangement patterns of linear light sources (or different arrangement intervals) due to different sizes, the same light holding members can be used. The distance between the first light source holding portion and the second light source holding portion can be adjusted with means of changing a distance between light source holding portions included in the light source holding members. Thus, the lighting device can accommodate different sizes of display devices. Even if the display devices have the same size, in consideration of cost and performance, the number of linear light sources or the arrangement patterns of linear light sources (or arrangement intervals) may be different. In such a case, the intervals of the light source holding portions can be adjusted properly with the means of changing a distance between light source holding portions. Namely, the lighting device can accommodate such different intervals.

According to the present invention, the same light source holding members can be used for different arrangement patterns of the linear light sources. Therefore, the lighting device for a display device can be used for different kinds of display devices, and thus contribute to reducing cost of the display devices and television receivers.

In one lighting device for a display device, even if the linear light sources are arranged at irregular intervals, that is, if the intervals are small in the central section of the lighting device and large in the end sections of the lighting device (irregular lamp pitch), the same light source holding members can be used. This is because the distance between the light source holding members can be adjusted for different intervals between the linear light sources. Therefore, the cost can be reduced in comparison with one that uses different light source holding members for different intervals between the linear light sources.

### BRIEF DESCRIPTION OF THE DRAWINGS

FIG. 1 is an exploded view illustrating the general construction of a television receiver according to embodiment 1 of the present invention;

FIG. 2 is an exploded view illustrating the general construction of a liquid crystal display device included in the television receiver illustrated in FIG. 1;

FIG. 3 is a cross-sectional view of the liquid crystal display device illustrated in FIG. 2 along the line A-A;

FIG. 4 is a plan view of a backlight device included in the liquid crystal display device;

FIG. 5 is a cross-sectional view illustrating the general construction of a lamp clip included in the backlight device;

FIG. 6 is a plan view illustrating the general construction of the lamp clip illustrated in FIG. 5 that holds cold cathode tubes;

FIG. 7 is an enlarged view of a main part of means of changing a distance between light source holding portions included in the lamp clip explaining a construction;

FIG. 8 is a plan view of the backlight device according to embodiment 2 of the present invention;

FIG. 9 is a cross-sectional view illustrating the general construction of a lamp clip included in the backlight device illustrated in FIG. 8;

FIG. 10 is a cross-sectional view illustrating the general construction of a lamp clip included in the backlight device according to embodiment 3 of the present invention; and

FIG. 11 is a perspective view illustrating a modification of mounting plate included in the lamp clip.

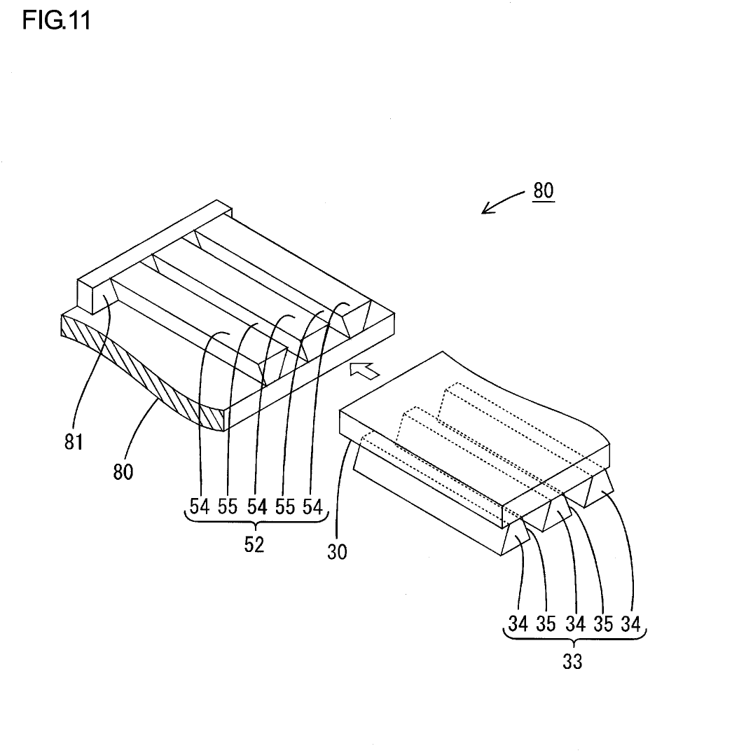

### BEST MODE FOR CARRYING OUT THE INVENTION

### Embodiment 1

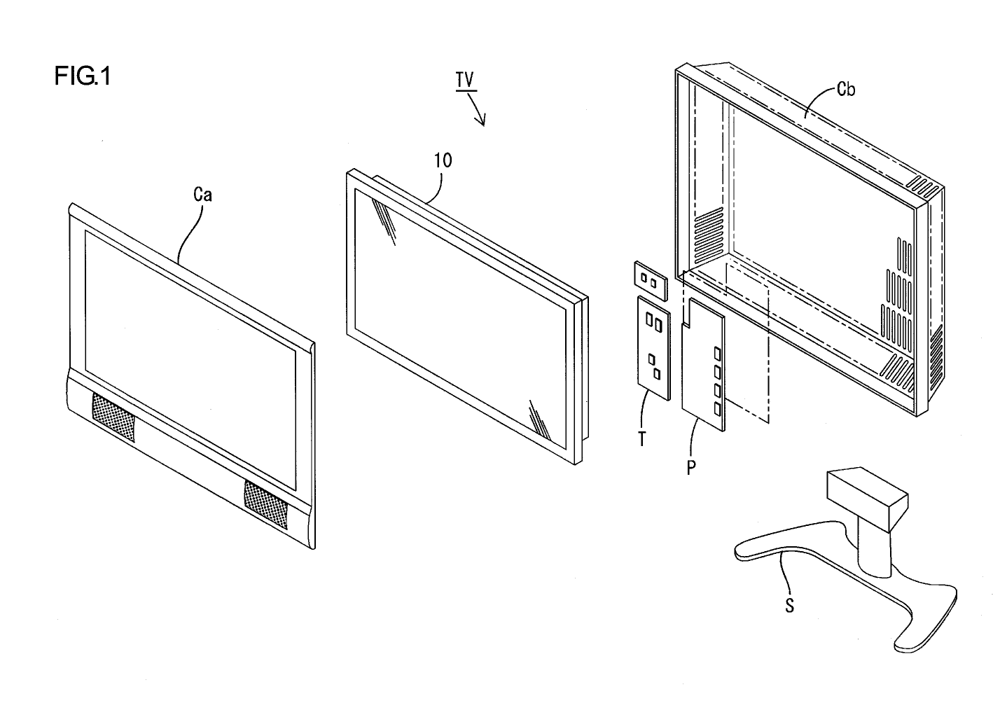

Embodiment 1 of the present invention will be explained with reference to FIGS. 1 to 7. In this embodiment, a television receiver TV including a liquid crystal display device 10 is used as an example.

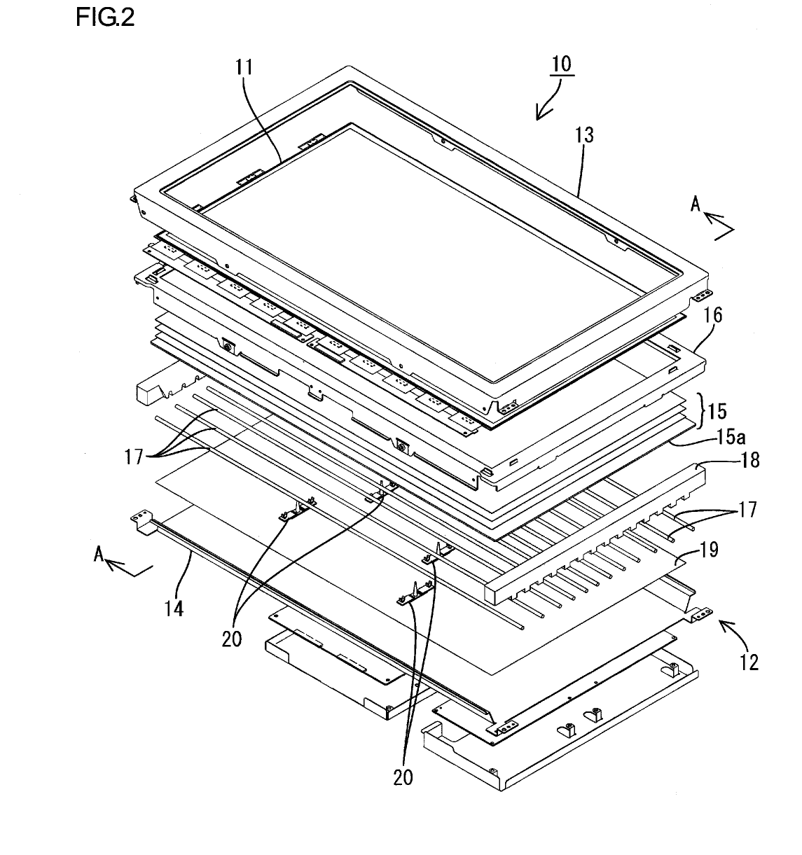

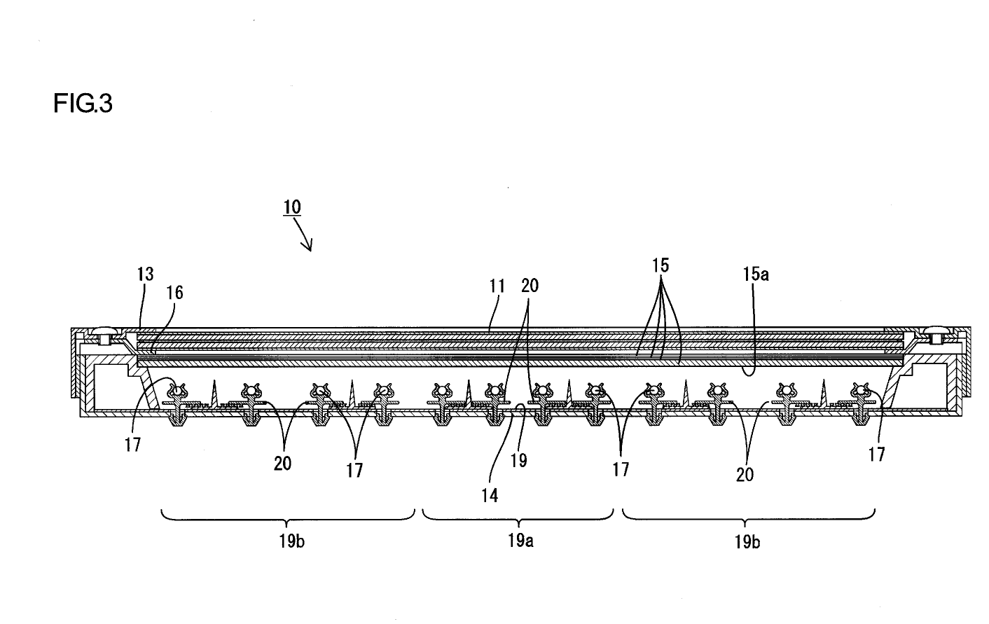

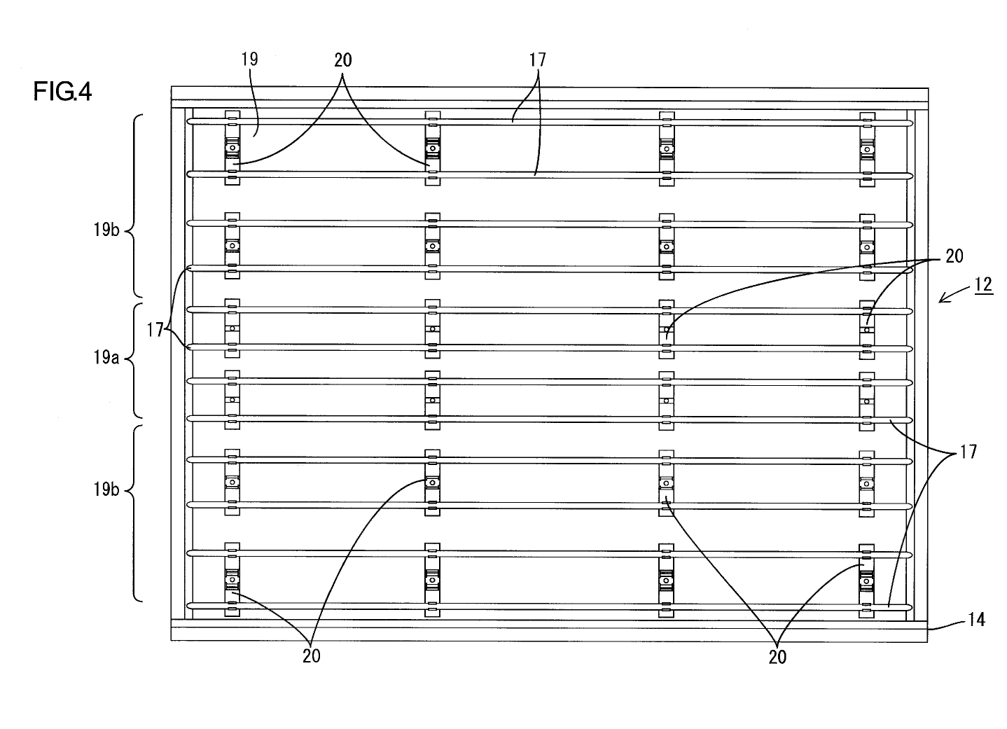

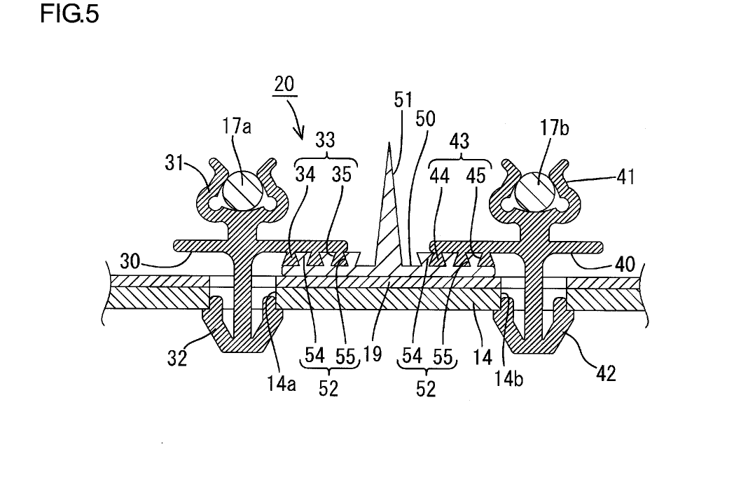

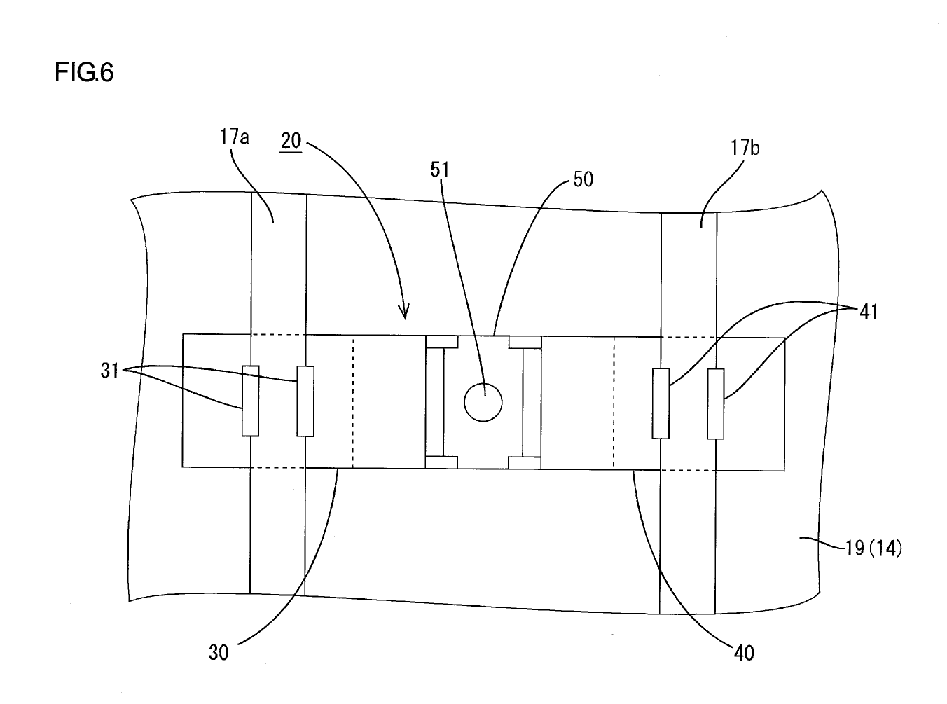

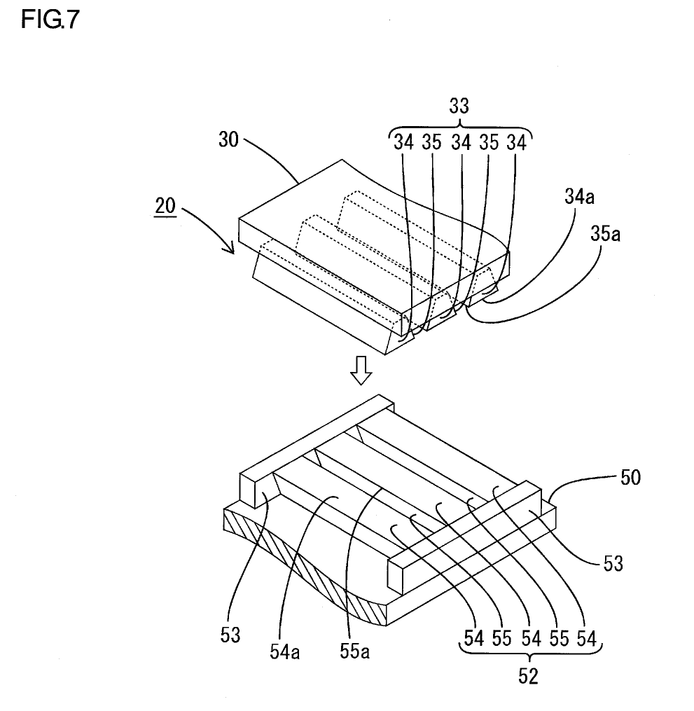

FIG. 1 is an exploded view illustrating the general construction of a television receiver according to embodiment 1 of the present invention. FIG. 2 is an exploded perspective view illustrating the general construction of a liquid crystal display device included in the television receiver illustrated in FIG. 1. FIG. 3 is a cross-sectional view of the liquid crystal display device illustrated in FIG. 2 along the line A-A. FIG. 4 is a plan view of a backlight device included in the liquid crystal display device. FIG. 5 is a cross-sectional view illustrating the general construction of a lamp clip included in the backlight device. FIG. 6 is a plan view illustrating the general construction of the lamp clip illustrated in FIG. 5 that holds cold cathode tubes. FIG. 7 is an enlarged view of a main part of means of changing a distance between light source holding portions included in the lamp clip explaining a construction.

The television receiver TV of the present embodiment, as illustrated in FIG. 1, includes the liquid crystal display device (display device) 10, front and rear cabinets Ca, Cb that houses the liquid crystal display device 10 therebetween, a power source P, a tuner T and a stand S. An overall shape of the liquid crystal display device 10 is a rectangle in landscape orientation. As illustrated in FIG. 2, it includes a liquid crystal panel 11, which is a display panel, and the backlight device 12, which is an external light source (lighting device for a display device). The liquid crystal panel 11 and the backlight device 12 are integrally held by a bezel 13 and the like.

Next, the liquid crystal panel 11 and the backlight device 12 that are included in the liquid crystal display device 10 will be explained (see FIGS. 2 and 3).

The liquid crystal panel (display panel) 11 includes a pair of glass substrates that are bonded with a predetermined gap therebetween and liquid crystal sealed between the glass substrates. On one of the glass substrates, switching components (e.g., TFTs) connected to source lines and gate lines that are perpendicular to each other and pixel electrodes and the like are formed. On the other glass substrate, a counter electrode and color filters in which R, G, B and the like color portions are formed in matrix are formed.

The backlight device 12 is a so-called direct-light type backlight device. It includes a plurality of linear light sources (cold cathode tubes 17 are used as high-pressure discharge tubes here) arranged closely below an opposite surface of the liquid crystal panel 11 from the panel surface (i.e., display surface) and along the panel surface.

The backlight device 12 further includes a chassis 14, a plurality of optical members 15 (a diffuser plate 15a, a diffusing sheet, a lens sheet and a reflection type polarizing plate, arranged in this order from the lower side of the drawings) and a frame 16. The chassis 14 has a substantially box-shape and an opening on the top. The optical members 15 are arranged so as to cover the opening of the backlight chassis 14. The frame 16 holds the optical members 15 to the backlight chassis 14. The cold cathode tubes 17 and lamp clips (light source holding member) 20 for holding the cold cathode tubes 17, and lamp holders 18 that cover ends of the cold cathode tubes 17 collectively are installed in the chassis 14. A light emitting side of the backlight device 12 is a side closer to the optical member 15 than the cold cathode tube 17.

A light reflecting surface is formed on an inner surface side (light source side) of the chassis 14 with light reflecting sheet 19. With the chassis 14 including such light reflecting sheet 19, light emitted from the cold cathode tubes 17 is reflected toward the optical members 15 including the diffuser plate 15a.

The cold cathode tubes 17 are linear light sources that extend in one direction. Each of them has an elongated tubular shape. A plurality of them (twelve tubes in FIG. 2) are housed in the chassis 14 such that a longitudinal direction (i.e., axial direction) thereof matches the longitudinal direction of the chassis 14 and arranged in parallel to each other. As illustrated in FIGS. 3 and 4, the cold cathode tubes 17 are arranged at a relatively small interval in a narrow pitch area 19a and at a relatively large interval in wide pitch areas 19b. The narrow pitch area 19a is located in a central section of the arrangement, that is, in a central section of the backlight device 12. The wide pitch areas 19b are located in end sections of the arrangement, that is, end sections of the backlight device 12. The cold cathode tubes 17 are fixed and held to the chassis 14 with the lamp clips 20.

As illustrated in FIG. 4, a plurality of lamp clips 20 can be mounted on the chassis 14 so as to hold each cold cathode tube 17 at different locations in a longitudinal direction of the cold cathode tube 17. Each lamp clip 20 is generally made of synthetic resin (e.g., polycarbonate) and elastically deformable. As illustrated in FIGS. 5 and 6, the first plate member (first member) 30 and the second plate member (second member) 40 are connected to a mounting plate (base plate portion) 50. The entire lamp clip 20 is colored in white, for example, so that it won't make a shadow by light emitted from the cold cathode tubes 17.

The mounting plate 50 has a longitudinal plate shape. It is mounted to the chassis 14 so as to extend along the short-side direction of the chassis 14. A supporting pin (supporting member) 51 for supporting the diffuser plate 15a that is located in the lowermost of the optical members 15 protrudes from the center of an upper surface of the mounting plate 50 (surface facing the optical members 15). The supporting pin 51 has a round cross section when it is cut in the surface direction of the diffuser plate 15a (see FIG. 6), and has a conical shape, a diameter of which gradually decreases from its base toward its tip.

Further, base plate ridged portions 52, which will be explained later, are formed in longitudinal end sections of the upper surface of the mounting plate 50 (i.e., on either side of the supporting pin 51). The first plate member 30 and the second plate member 40 are connected to the upper surface of the mounting plate 50 via the ridged portions 52.

The first plate member 30 and the second plate member 40 both have rectangular shapes. As illustrated in FIG. 5, they are connected to the mounting plate 50 with their longitudinal direction matching the longitudinal direction of the mounting plate 50.

A lamp holding portion 31 (first light source holding portion) for holding the cold cathode tube 17a (first linear light source) is formed on an upper surface (a surface facing the cold cathode tube 17) of the first plate member 30 in a longitudinal end section of the first plate member 30. A lamp holding portion 41 (second light source holding portion) for holding the cold cathode tube 17b (second linear light source) is formed on an upper surface (a surface facing the cold cathode tube 17) of the second plate member 40 in a longitudinal end section of the first plate member 40. The lamp holding portions 31, 41 are formed along the parallel direction of the cold cathode tubes 17a, 17b not along the longitudinal direction of the cold cathode tubes 17.

The lamp holding portions 31, 41 can generally hold a part or an entire periphery of the cold cathode tube 17. Moreover, they have annular shapes with open ends in the upper part for allowing attachment and removal of the cold cathode tubes 17.

As illustrated in FIG. 5, stoppers 32, 42 are formed so as to protrude from the lower surfaces (surfaces facing the chassis 14, or opposite surfaces from the lamp holding portions 31, 41) of the first plate member 30 and the second plate member 40 toward the chassis 14. More specifically, the stopper 32 is formed on the first plate member 30 directly below the lamp holding portion 31 (on an opposite side of the first plate member 30 from the lamp holding portion 31). The stopper 42 is formed on the second plate member 40 directly below the lamp holding portion 41 (on an opposite side of the second plate member 40 from the lamp holding portion 41). The first plate member 30 and the second plate member 40 are engaged in the chassis 14 by fitting the stoppers 32, 42 in mounting holes 14a, 14b formed in the chassis 14.

Further, the first ridged portion 33 and the second ridged portion 43 are formed on the lower surfaces of the first plate member 30 and the second plate member 40, respectively. The first ridged portion 33 and the second ridged portion 43 have a plurality of longitudinal projections and grooves that extend in the short-side direction of the first plate member 30 and the second plate member 40 (i.e., in the direction perpendicular to the parallel direction of the cold cathode tubes 17), and are formed alternatively in parallel. Each projection 34, 44 has a substantially triangular cross section, widths of which become gradually large from its base toward its top, and a top portion 34a, 44a has the maximum width. Namely, a plurality of projections 34, 44, each of which has a substantially triangular cross section, are formed along the parallel direction of the cold cathode tubes 17 in the first ridged portion 33 and the second ridged portion 43. Each groove 35 between the adjacent projections 34 and each groove 45 between the adjacent projections 44 have widths that gradually become small from the first plate member 30 side or the second plate member side 40 toward their openings. The widths of opening ends 35a, 45a are the smallest.

As illustrated in FIG. 7, a base plate ridged portion 52 is formed on the top surface of the mounting plate 50. The base plate ridged portion 52 includes longitudinal projections and grooves that extend along the short-side direction of the mounting plate 50 (in the direction perpendicular to the parallel direction of the cold cathode tubes 17). It further includes positioning walls 53 formed on either side of the base plate ridged portion 52.

The base plate ridged portion 52 includes longitudinal projections 54 and grooves 55 that are formed alternatively in parallel. Each projection 54 has a substantially inverted triangular cross section, widths of which become gradually large from its base toward its top, and a top portion 54a has the maximum width. Namely, a plurality of triangular prism-shaped projections 54 are formed in parallel along the parallel direction of the cold cathode tubes 17 in the base plate ridged portion 52. Each groove 55 between the adjacent projections 54 has a cross section, widths of which become gradually small from the mounting plate 50 side toward its opening. The width of opening end 55a is the smallest.

The positioning walls 53 are formed in a rectangular shape and along the longitudinal direction of the mounting plate 50 (the parallel direction of the cold cathode tubes) and along ends of the projections 54 and the grooves 55 of the base plate ridged portion 52.

A distance between the lamp holding portions 31, 41 of the above lamp clip 20 is variable. The distance can be varied in the long-side direction of the first plate member 30, the second plate member 40 and the mounting plate 50, that is, in the parallel direction of the cold cathode tubes 17. Next, an example of how the lamp clip 20 is used will be explained using the first plate member 30 and the mounting plate 50, with reference to FIG. 7.

First, the first plate member 30 and the mounting plate 50 are placed such that either end of each projection or groove of the first ridged portion 33 is flush with an inner side of the positioning wall 53. This restricts the first plate member 30 from moving in a direction perpendicular to a direction in which the distance between the lamp holding portions 31, 41 is variable. Next, the first ridged portion 33 is pressed down to the base plate ridged portion 52 and engaged therein. As a result, the first plate member 30 is connected to the mounting plate 50. Namely, the projections 34 of the first ridged portion 33 are fitted in the grooves 55 of the base plate ridged portion 52 and the projections 54 of the base plate ridged portion 52 are fitted in the grooves 35 of the first ridged portion 33. Especially in this embodiment, the width of the top portion 34a of the projection 34 having the maximum width is larger than that of the opening end 55a of the groove 55 of the base plate ridged portion 52. The top portion 54a of the projection 54 having the maximum width is larger than that of the opening end 35a of the groove 35 of the first ridged portion 33. Therefore, force strong enough to cause elastic deformation of the projections 34, 54 made of synthetic resin having elasticity needs to be applied to engage the first ridged portion 33 in the base plate ridged portion 52.

The second plate member 40 can be connected to the mounting plate 50 in the same manner.

The first ridged portion 33 and the base plate ridged portion 52 include a plurality of projections 34, 54 and grooves 35, 55, respectively. By selecting the preferable grooves 35, 55 in which the projections 34, 54 are respectively fitted, a relative position of the lamp holding portion 31 in the lamp clip 20 can be changed.

When the projection 34 in an end section of the first plate member 30 is fitted in the groove 55 in the center section of the mounting plate 50, the first plate member 30 is connected relatively center of the mounting plate 50. As a result, the lamp holding portion 31 is positioned in a relatively center section of the mounting plate 50. When the second plate member 40 is connected to the mounting plate 50 in the same manner, the lamp holding portion 41 is positioned also in the relatively center section of the mounting plate 50. As a result, the distance between the lamp holding portions 31, 41 is set relatively small.

On the other hand, when the projection 34 in the end section of the first plate member 30 is fitted in the groove 55 in the end section of the mounting plate 50, the first plate member 30 is connected relatively end of the mounting plate 50. As a result, the lamp holding portion 31 is positioned in a relatively end section of the mounting plate 50. When the second plate member 40 is connected to the mounting plate 50 in the same manner, the second plate member 40 is connected relatively end of the mounting plate 50, the lamp holding portion 41 is positioned in a relatively end section of the mounting plate 50. As a result, the distance between the lamp holding portions 31, 41 is set relatively large.

In the lamp clip 20, the projections 34, 44, 54 and the grooves 35, 45, 55 extend in a direction perpendicular to the parallel direction of the cold cathode tubes 17 (i.e., in a direction across the direction in which the distance between the lamp holing portions 31, 41 is variable). By changing locations in which the projections 34, 44, 54 are fitted in the respective grooves 35, 45, 55, the distance between the lamp holding portions 31, 41 can be changed. The first ridged portion 33, the second ridged portion 43 and the base plate ridged portion 52 function as means of changing a distance between light source holding portions.

The television receiver TV, the liquid crystal display device 10 and the backlight device 12 of the present embodiment having the above configuration provide the following operational effects.

Each lamp clip 20 included in the backlight device 12 of the present embodiment has the lamp holding portion 31 formed on the first plate member 30 and means of changing a distance between light source holding portions for changing the distance between the lamp holding portion 31 and the lamp holding portion 41 formed on the second plate member 40.

With this configuration, the distance between the lamp holding portions 31, 41 can be set differently for one lamp clip 20. As a result, when the cold cathode tubes 17a, 17b are held by those lamp holding portions 31, 41, the distance between the cold cathode tubes 17a, 17b held by the same lamp clip 20 can be set differently. The same lamp clips can be used even when the cold cathode tubes 17 are arranged at different intervals, for example.

In this embodiment, the first plate member 30, the second plate member 40 and the mounting plate 50 have the first ridged portion 33, the second ridged portion 43 and the base plate ridged portions 52, respectively. By changing locations to engage the first ridged portion 33 and the second ridged portion 43 in the base plate ridged portions 52, the distance between the lamp holding portions 31, 41 can be changed.

With a simple configuration such as engagement of grooves and projections and by changing the locations in which the projection and the grooves are fitted, the distance between the lamp holding portions 31, 41 can be set according to arrangement patterns (or arrangement intervals) of the cold cathode tubes 17. The same members can be used for the first plate member 30 and the second plate member 40. Therefore, the first plate member 30 and the second plate member 40 need not be sorted in an assembly process, that is, the sorting time can be cut.

In this embodiment, the diffuser plate 15a for diffusing light emitted from the cold cathode tubes 17 is arranged on the light emitting side of the cold cathode tubes 17. Moreover, the supporting pin 51 for supporting the diffuser plate 15a is formed on the mounting plate 50.

The supporting pin 51 restricts deformation of the diffuser plate 51a and therefore the light emitted from the cold cathode tubes 17 are evenly diffused. Especially by forming the supporting pin 51 on the mounting plate 50, the supporting pin 51 in combination with the first plate member or the second plate member having the lamp holding portion 31, 41 can accommodate various combinations of arrangement patterns of the cold cathode tubes 17 and supporting positions of the diffuser plate 15a.

In this embodiment, the projections 34, 44, 54 and the grooves 35, 45, 55 included in the first ridged portion 33, the second ridged portion 43 and the base plate ridged portions 55, respectively are formed such that their longitudinal directions are set along a direction perpendicular to the parallel direction of the cold cathode tubes 17, that is, along a direction across the direction in which the distance between the lamp holding portions 31, 41 is variable.

With this configuration, when the projections 34, 44, 54 are fitted in the grooves 35, 45, 55, large contact areas are obtained. High load is applied to the first ridged portion 33 or the second ridged portion 43 to shift in the lamp holding portion 31 or 41. Therefore, the distance between the lamp holding portions 31, 41 that are once set does not easily change.

In this embodiment, the first ridged portion 33, the second ridged portion 43 and the base plate ridged portion 52 are made of elastically deformable material. Further, the widths of the opening ends of the grooves 35, 45, 55 are smaller than the maximum widths of the projections 34, 44, 54 at their tops 34a, 44a, 54a.

With this configuration, when fitting or removing the projections 34, 44, 54 in or from the grooves 35, 45, 55, the tops 34a, 44a, 55a of the projections 34, 44, 54 pass through the opening ends 35a, 45a, 55a of the grooves 35, 45, 55 with elastic deformation. Namely, removal of the projections 34, 44, 54 from the grooves 35, 45, 55 requires pulling force strong enough to cause elastic deformation of the projections 34, 44, 54. Therefore, when the projections 34, 44, 54 are once fitted in the grooves 35, 45, 55, they are not easily removed. As a result, the set distance between the lamp holding portions 31, 41 does not easily change, and the cold cathode tubes 17 are properly positioned without stress applied to the cold cathode tubes 17. Because the projections 34, 44, 54 are not easily removed from the grooves 35, 45, 55, the lamp clips 20 in each of which the distance between the lamp holding portions 31, 41 is set according to the arrangement pattern of the cold cathode tubes 17 can be prepared in advance. Therefore, efficiency in assembly work improves.

In this embodiment, the mounting plate 50 has the positioning walls 53 for restricting the first plate member 30 and the second plate member 40 from shifting in the direction across the direction in which the distance between the lamp holding portions 31, 41 is variable.

With this configuration, the shift of the first plate member 30 and the second plate member 40 in the direction across the direction in which the distance between the lamp holding portions 31, 41 is variable can be restricted. Thus, the first plate member 30 and the second plate member 40 are less likely to come off and stress is not applied to the cold cathode tubes 17.

In this embodiment, the lamp clip 20 has the stoppers 32, 42 that can be inserted and fitted in the mounting holes 14a, 14b formed in the chassis 14 while penetrating toward the chassis 14 side.

With this configuration, the cold cathode tubes 17 are protected by the chassis 14 and the lamp clips 20 are mounted preferably to the chassis 14 with the stoppers 32, 42 engaged in the chassis 14.

In this embodiment, the stoppers 32, 42 are formed on the first plate member 30 and the second plate member 40, respectively. They protrude to a side opposite from the lamp holding portions 31, 41.

As the stoppers 32, 42 are formed on the first plate member 30 and the second plate member 40, respectively, the cold cathode tubes 17 are properly installed in the chassis 14. Moreover, because the stoppers 32, 42 protrude to the side opposite from the lamp holding portions 31, 41, the cold cathode tubes 17 can be arranged on an inner surface side of the chassis 14.

In this embodiment, a plurality of the cold cathode tubes 17 are arranged in parallel. The narrow pitch area 19a in which the arrangement interval is relatively small is located in the central section of the arrangement. The wide pitch areas 19b in which the arrangement interval is relatively large are located in the end sections of the arrangement.

By arranging the cold cathode tubes 17 such that the narrow pitch area 19a is located in the central section of the arrangement, the luminance of the backlight device 12 is enhanced in the central section of the arrangement. As a result, the visibility of the display surface of the liquid crystal display device 10 or the television receiver TV each having the backlight device 12 improves.

Furthermore, the distance between the lamp holding portions 31, 41 of each lamp clip 20 can be adjusted for different arrangement intervals of the cold cathode tubes 17. Therefore, the same lamp clips 20 be used for supporting the cold cathode tubes 17 arranged at different intervals. As a result, the cost related the lamp clips 20 can be saved and the lamp clips 20 need not be sorted, that is, the sorting time can be cut.

### Embodiment 2

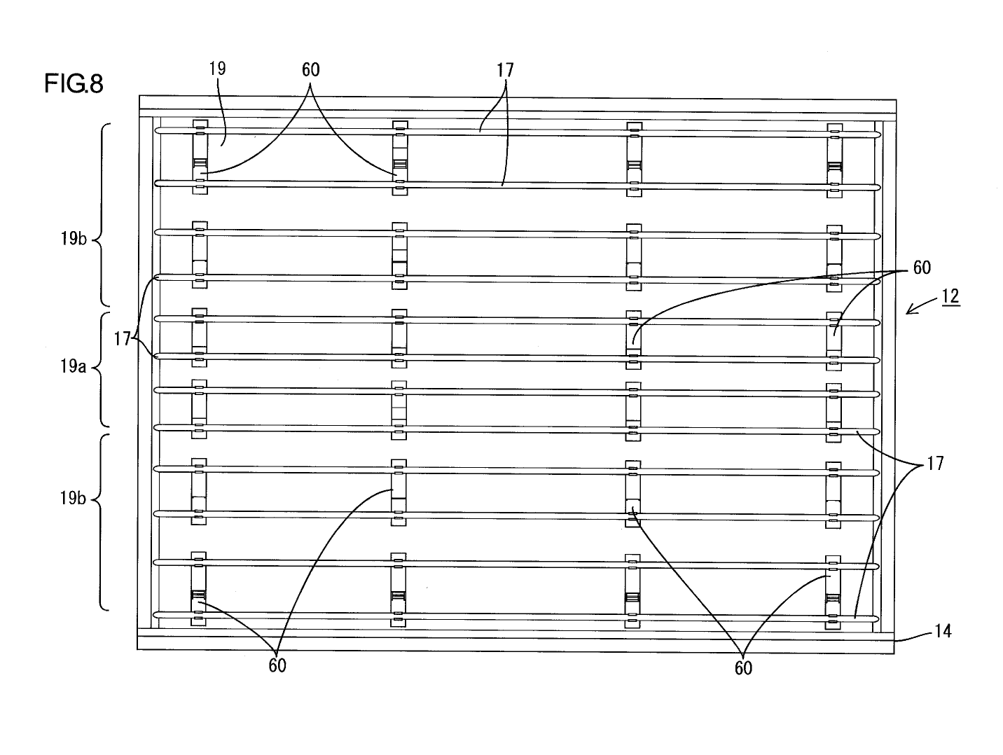

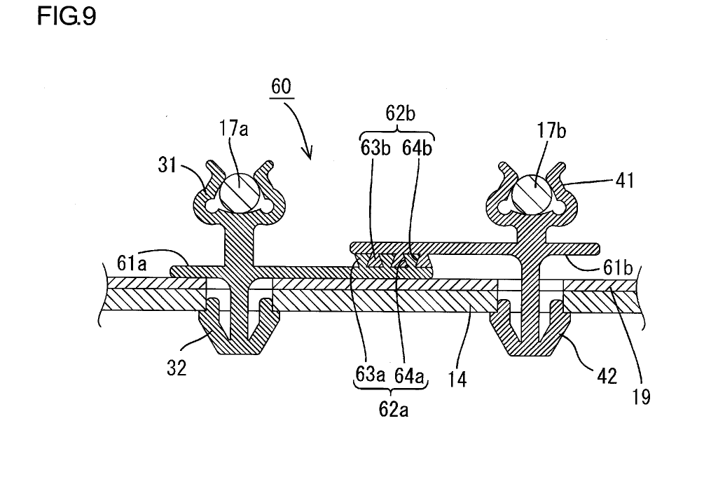

Next, embodiment 2 of the present invention will be explained with reference to FIGS. 8 and 9. In embodiment 2, the configuration of the lamp clips is different. Other configurations are the same as the previous embodiment. The same parts as the previous embodiment are indicated with the same symbols and will not be explained.

FIG. 8 is a plan view of the backlight device according to the present embodiment. FIG. 9 is a cross-sectional view illustrating the general construction of a lamp clip included in the backlight device illustrate in FIG. 8.

As shown in FIG. 8, a plurality of lamp clips 60 are mounted to the chassis 14 so as to hold the cold cathode tubes 17 in different locations in the longitudinal direction of the cold cathode tubes 17. Each lamp clip 60 is generally made of synthetic resin (e.g., polycarbonate) that is elastically deformable. As shown in FIG. 9, it includes the first plate member 61a and the second plate member 61b.

The lamp holding portion 31, 41 are formed on the respective longitudinal ends of top surfaces of the first plate member 61a and the second plate member 61b (i.e., surfaces opposite from the cold cathode tubes 17) for holding the cold cathode tubes 17a, 17b, respectively. The stoppers 32, 42 to be engaged in the chassis 14 are formed directly below the lamp holding portions 31, 41 (on bottom surfaces of the first plate member 61a and the second plate member 61b).

The first ridged portion 62a is formed in an end section of the top surface of the first plate member 61a away from the lamp holding portion 31. The first ridged portion 62a has a plurality of projections and grooves that extend in the short-side direction of the first plate member 61a (i.e., in the direction perpendicular to the parallel direction of the cold cathode tubes 17) and are formed alternatively in parallel. Each projection 63a has a substantially inverted triangular cross section, widths of which gradually become large from its base toward its top. Each groove 64a between the adjacent projections 63a has widths that gradually become small from the first plate member 61a side toward its opening.

The second ridged portion 62b has a structure in which a plurality of projections and grooves that extend in the short-side direction of the second plate member 61b (i.e., in the direction perpendicular to the parallel direction of the cold cathode tubes 17) are formed alternatively in parallel. Each projection 63b has a substantially inverted triangular cross section, widths of which gradually become large from its base toward its top. Each groove 64b between the adjacent projections 63b has widths that gradually become small from the second plate member 61b side toward its opening.

The first plate member 61a and the second plate member 61b are connected with each other when the first ridged portion 62a and the second ridged portions 62b are engaged. Namely, the projections 63a of the first ridged portion 62a are fitted in the grooves 64b of the second ridged portion 62b and the projections 63b of the second ridged portion 62b are fitted in the grooves 64a of the first ridged portion 62a.

Furthermore, the first ridged portion 62a and the second ridged portion 62b include a plurality of projections 63a, 63b and grooves 64a, 64b, respectively. By selecting the preferable grooves 64a, 64b to fit the projections 63a, 63b, the distance between the lamp holding portions 31, 41 of the lamp clip 60 can be changed.

Namely, when the projection 63b located in the end section of the second plate member 61b is fitted in the groove 64a located in the central section of the first plate member 61a, the second plate member 61b is connected relatively center of the first plate member 61a. This makes the distance between the lamp holding portions 31, 41 small.

When the projection 63b located in the end section of the second plate member 61b is fitted in the groove 64a located in the end section of the first plate member 61a, the second plate member 61b is connected relatively end of the first plate member 61a. This makes the distance between the lamp holding portions 31, 41 large.

In each of the lamp clips 60, the distance between the lamp holding portions 31, 41 can be changed according to the locations in which the projections 63a, 63b are fitted in the respective grooves 64a, 64b. Namely, the first ridged portion 62a and the second ridged portion 62b function as means of changing a distance between light source holding portions for changing the distance between the lamp holding portions 31, 41.

Each lamp clip 60 included in the backlight device 12 of the present embodiment has the first plate member 61a and the second plate member 61b. By changing the location in which the first ridged portion 62a of the first plate member 61a is fitted in the second ridged portion 62b of the second plate member 61b, the distance between the lamp holding portions 31, 41 can be changed.

With this configuration, only two kind of members, the first plate member 61a and the second plate member 61b, are required to accommodate different arrangements of the cold cathode tubes 17. This makes cost saving possible. By changing the location in which the first ridged portion 62a is fitted in the second ridged portion 62b, the distance between the lamp holding portions 31, 41 is changed. Thus, the distance can be gradually changed. Moreover, the distance that is once set does not change easily depending on the strength of the engagement. The cold cathode tubes 17 are properly positioned without stress applied to the cold cathode tubes 17. Therefore, the means of changing a distance between light source holding portions preferably functions.

### Embodiment 3

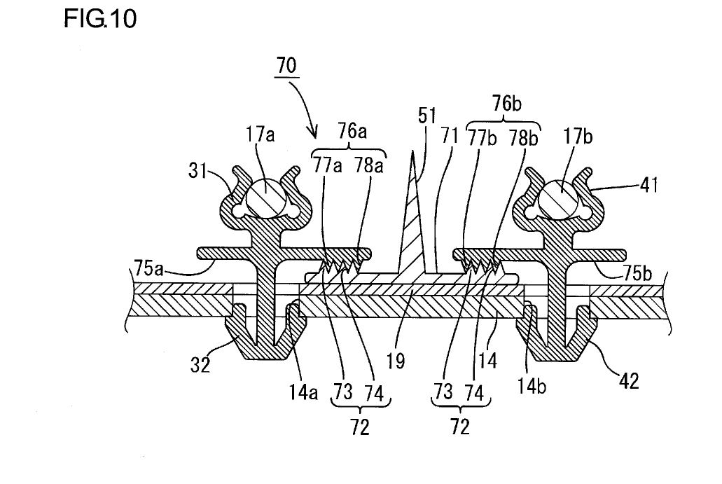

Embodiment 3 of the present invention will be explained with reference to FIG. 10. In embodiment 3, the configurations of the projections and grooves are different. Other configurations are the same as the previous embodiment. The same parts as the previous embodiment are indicated with the same symbols and will not be explained.

FIG. 10 is a cross-sectional view illustrating the general construction of a lamp clip included in the backlight device according to the present embodiment.

As illustrate in FIG. 10, the lamp clip 70 includes the first plate member 75a and the second plate member 75b connected to a mounting plate 71.

The mounting plate 71 has a longitudinal plate shape that extends in the parallel direction of the cold cathode tubes 17. On an upper surface of the mounting plate 71, the supporting pin 51 projects from its center. Base plate ridged portions 72 are formed in longitudinal end sections (i.e., on either side of the supporting pin 51) on the upper surface of the mounting plate 71.

The base plate ridged portions 72 include projections 73 and grooves 74 that extend in the short-side direction of the mounting plate 71 (a direction perpendicular to the parallel direction of the cold cathode tubes 17) and are formed alternatively in parallel. Each projection 73 has a triangular cross section with pointy tips, widths of which gradually become small from its base toward its top. Each groove 74 has a cross section, widths of which gradually become large from the mounting plate 71 side toward its opening. The width of opening end is the largest.

The first plate member 75a and the second plate member 75b both have rectangular shapes. They are connected to the mounting plate 71 as their longitudinal direction matches that of the mounting plate 71. The first ridged portions 76a and the second ridged portion 76b are formed on lower surfaces of the first plate member 75a and the second plate member 75b in one of their longitudinal end sections, respectively. The first ridged portion 76a and the second ridged portion 76b include projections 77a, 77b and grooves 778a, 78b that extend in the short-side direction of the first plate member 75a and the second plate member 75b (i.e., a direction perpendicular to the parallel direction of the cold cathode tubes 17) and are formed alternatively in parallel. Each projection 77a, 77b has a triangular cross section with pointy tips, widths of which gradually become small from its base toward its top. Each groove 78a, 78b has a cross section, widths of which gradually become large from the mounting plate 71 side toward its opening. The width of opening end is the largest.

The first plate member 75a and the second plate member 75b are connected to the mounting plate 71 by engaging the first ridged portion 77a and the second ridged portion 77b in the base plate ridged portions 72, respectively. Especially in this embodiment, the width of the opening end of the grooves 78a, 78b that are included in the first ridged portion 76a and the second ridged portion 76b, respectively is larger than the tip of the projections 73 of the base plate ridged portions 72 and as same as the width of the base of the projections 73, which is the largest width. Moreover, the width of the opening end of the grooves 74 that is included in the base plate ridged portions 72 is larger than the widths of the top of the projections 77a, 77b in the first ridge portion 76a and the second ridged portion 76b, and as same as the width of the base of the projections 77a, 77b, which is the largest width.

Each lamp clip 70 included in the backlight device 12 of the present embodiment has the first ridged portion 76a, the second ridged portion 76b and the base plate ridged portions 72. Each projection 73, 77a, 77b of the first ridged portion 77a, the second ridged portion 77b and the base plate ridged portions 72 has a form of protrusion, widths of which gradually become small toward its top and the width of the top is smaller than that of the opening end of each groove 74, 78a, 78b.

With this configuration, when the first ridged portion 76a and the second ridged portion 76b are engaged in the base plate ridged portion 72, the projections 73, 77a, 77b are smoothly fitted in the grooves 74, 78a, 78b. This improves efficiency in assembly work. The mounting plate 71 is placed in a predetermined location of the chassis 14, and the first plate member 75a and the second plate member 75b are engaged in the chassis 14 when they are connected to the mounting plate 71. In this case, the mounting plate 71 is fixed to the chassis 14 via the first plate member 75a and the second plate member 75b.

### Other Embodiment

The present invention is not limited to the embodiments explained in the above description made with reference to the drawings. The following embodiments may be included in the technical scope of the present invention, for example.

(1) In the above embodiment 1, the first plate member 30 and the second plate member 40 are connected to the mounting plate 50 by pressing them down to the mounting plate 50. However, the first plate member 30 may be connected to a mounting plate 80 by sliding it from the side of the mounting plate 80. In this case, the positioning wall 53 of the mounting plate 80 is provided only on a side that is an end of the insertion direction of the first plate member 30.

In the configuration of embodiment 2 that does not include the mounting plate 50, the first plate member and the second plate member may be connected together from the side.

(2) In the above embodiment 1, the lamp clip 20 has the first plate member 30 and the second plate member 40 connected to the mounting plate 50 for holding two cold cathode tubes 17. However, the first plate member can have two or more lamp holding portions or the third plate member and the like may be connected to hold three or more cold cathode tubes 17.

In embodiment 2 that does not include the mounting plate 50, three or more cold cathode tubes 17 may be held in the same manner as above.

(3) In the above embodiment 1, the lamp holding portions 31, 41 and the stoppers 32, 42 are formed in the end sections of the first plate member 30 and the second plate member 40, respectively. However, locations where the lamp holding portions and the stoppers are formed are not limited to the above locations. For example, they may be formed in the central sections of the first plate member and the second plate member. The stoppers may be formed in locations other than the directly below the lamp holding portions.

(4) In the above embodiments, the first plate member and the second plate member have rectangular shapes. However, they may be formed in different shapes. Moreover, the first plate member and the second plate member may have different lamp clips in shape and size.

(5) In the above embodiments, the lamp clips are made of synthetic resin and polycarbonate ones are used as examples. However, they can be made of other synthetic resin.

(6) In the above embodiments, the cold cathode tubes 17, 17 are arranged at different intervals (irregular lamp pitch). However, they may be arranged at an equal interval.

(7) In the above embodiments, the cold cathode tubes 17 are used as linear light sources. However, other types of linear light sources such as hot cathode tubes may be used.

(8) In the above embodiments, the liquid crystal display device using a liquid crystal panel as a display panel is used. However, the present invention can be applied to a display device using other types of display panels.

1. A lighting device for a display device, comprising:
a plurality of linear light sources; and
a light source holding member that holds said plurality of linear light sources, wherein:
said light source holding member includes a first member and a second member;
said first member has a first light source holding portion for directly holding a first linear light source of said plurality of linear light sources;
said second member has a second light source holding portion for directly holding a second linear light source that is different from said first linear light source; and
said light source holding member has means of changing a distance between light source holding portions for changing a distance between said first light source holding portion and said second light source holding portion.

2. A lighting device for a display device, as in claim 1, wherein:
said means of changing a distance between light source holding portions includes a first ridged portion formed in said first member and a second ridged portion formed in said second member;
said first ridged portion and said second ridged portion are capable of engaging with each other; and
said means of changing a distance between light source holding portions is capable of changing the distance between said first light source holding portion and said second light source holding portion by changing a location in which said first ridged portion and said second ridged portion are engaged.

3. A lighting device for a display device, as in claim 1, wherein:
said light source holding member further includes a base plate portion to which said first member and said second member are connectable;
said means of changing a distance between light source holding portions includes a first ridged portion formed in said first member, a second ridged portion formed in said second member, and a base plate ridged portion formed in said base plate portion;
said first ridged portion and said second ridged portion are engageable in the said base plate ridged portion; and
said means of changing a distance between light source holding portions is capable of changing the distance between said first light source holding portion and said second light source holding portion by changing locations in which said first ridged portion and said second ridged portion are engaged in said base plate ridged portion.

4. A lighting device for a display device, as in claim 3, further comprising:
a diffuser plate for diffusing light emitted from said plurality of linear light sources on a light emitting side of said plurality of linear light sources; and
a supporting member for supporting said diffuser plate in said base plate portion.

5. A lighting device for a display device, as in claim 4, wherein:
said means of changing a distance between light source holding portions includes longitudinal projections and longitudinal grooves; and
said longitudinal projections and said longitudinal grooves are formed such that a longitudinal direction thereof is set across a direction in which the distance between said first light source holding portion and said second light source holding portion is variable.

6. A lighting device for a display device, as in claim 5, wherein:
said means of changing a distance between light source holding portions is made of elastic material; and
each of said grooves has an opening end with a width smaller than a largest width of each of said projections.

7. A lighting device for a display device, as in claim 1, wherein
said light source holding member includes means of restricting a shift of said first member or said second member in a direction across a direction in which the distance between said first light source holding portion and said second light source holding portion is variable.

8. A lighting device for a display device, as in claim 1, further comprising a chassis in which said plurality of linear light sources are installed, wherein
said light source holding member protrudes toward said chassis and has a stopper that is engageable in a mounting hole formed in said chassis.

9. A lighting device for a display device, as in claim 8, wherein:
said stopper is formed in at least one of said first member and said second member; and
said stopper protrudes toward a side opposite from said first light source holding member and said second light source holding member.

10. A lighting device for a display device, as in claim 1, wherein
said plurality of linear light sources are arranged in parallel at a relatively small interval in a narrow pitch area and at a relatively large interval in a wide pitch area.

11. A lighting device for a display device, as in claim 1, wherein:
said narrow pitch area is located in a central section of arrangement of said plurality of linear light sources; and
said wide pitch area is located in an end section of arrangement of said plurality of linear light sources.

12. A display device comprising:
a lighting device for a display device, as in claim 1; and
a display panel for providing display by use of light from said lighting device for a display device.

13. A display device as in claim 12, wherein said display panel is a liquid crystal panel that uses liquid crystal.

14. A television receiver comprising a display device as in claim 12.
